(19) United States
(12) Patent Application Publication
(10) Pub. No.: US 2019/0123496 A1
(43) Pub. Date: Apr. 25, 2019

(54) HUB APPARATUS

(71) Applicant: Primax Electronics Ltd., Taipei City (TW)

(72) Inventors: Tung-Heng Wu, Taipei City (TW); Ying-Che Tseng, Taipei City (TW)

(21) Appl. No.: 15/906,524

(22) Filed: Feb. 27, 2018

(30) Foreign Application Priority Data
Oct. 20, 2017 (TW) 106136198

(51) Int. Cl. H01R 13/713; G06F 1/16; H01R 13/66; H01R 24/64; G06F 1/26

(52) U.S. Cl. CPC H01R 13/713; G06F 1/1632; H01R 2107/00; H01R 24/64; G06F 1/266; H01R 13/6683

(57) ABSTRACT

The present invention provides a hub apparatus, including a connection portion, an interface detection portion electrically coupled to the connection portion, a power control portion electrically coupled to the connection portion, a hub control portion electrically coupled to the power control portion, and a microcontroller electrically coupled to the interface detection portion, the power control portion, and the hub control portion, and after the microcontroller obtains, by using the interface detection portion, an interface type of an electronic apparatus connected to the connection portion, the microcontroller controls the hub control portion according to the interface type of the electronic apparatus to supply corresponding power to the connection portion by using the power control portion.

### FIELD OF THE INVENTION

The present invention relates to the field of data file and power transmission apparatuses, and in particular, to a hub apparatus.

### BACKGROUND OF THE INVENTION

With the development of current technologies, various electronic apparatuses, such as desktop computers, notebook computers, tablets, personal digital assistants (PDAs), smartphones, portable hard drives, flash drives, printers, transaction machines, mouse devices, keyboards, or cameras, have gradually become assistive tools indispensable in people's life or work. When various electronic apparatuses are used, a large number of data files are also generated, and data file transmission or power transmission is usually performed between different electronic apparatuses by using different transmission interfaces. Therefore, a hub apparatus is developed to facilitate people's operational needs.

Referring to FIG. 1, FIG. 1 is a schematic conceptual operational diagram of a conventional hub apparatus and an electronic computer apparatus. A hub apparatus 9 is electrically connected to an electronic computer 8, and includes a USB 2.0 connection portion 91, a USB 3.0 connection portion 92, and a USB 3.1 connection portion 93. A first electronic apparatus 71 may be connected to the USB 2.0 connection portion 91 by using a connection line with a USB 2.0 interface type, so that the electronic computer 8 can perform data file or power transmission with the first electronic apparatus 71. A second electronic apparatus 72 may be connected to the USB 3.0 connection portion 92 by using a connection line with a USB 3.0 interface type, so that the electronic computer 8 can perform data file or power transmission with the second electronic apparatus 72. Likewise, a third electronic apparatus 73 may be connected to the USB 3.1 connection portion 93 by using a connection line with a USB 3.1 interface type, so that the electronic computer 8 can perform data file or power transmission with the third electronic apparatus 73.

Generally, when the electronic computer 8 is simultaneously connected to the first electronic apparatus 71, the second electronic apparatus 72, and the third electronic apparatus 73 by using the hub apparatus 9, power that can be output by the electronic computer 8 is averagely transmitted to the USB 2.0 connection portion 91, the USB 3.0 connection portion 92, and the USB 3.1 connection portion 93 of the hub apparatus 9, so that the first electronic apparatus 71, the second electronic apparatus 72, and the third electronic apparatus 73 respectively obtain same power. However, in some use statuses, averagely allocated power causes inconvenience and disadvantages in use. For example, the same power may exceed a maximum power load (500 mA) of the specification of the USB 2.0 interface type, but is insufficient to drive the third electronic apparatus 73 connected to the USB 3.0 connection portion 92. In addition, the maximum power that can be output by the electronic computer 8 may also be incapable of keeping the USB 2.0 connection portion 91 (500 mA), the USB 3.0 connection portion 92 (900 mA), and the USB 3.1 connection portion 93 (900 mA) all in the maximum power load.

According to the foregoing descriptions, the conventional hub apparatus needs to be improved.

### SUMMARY OF THE INVENTION

A main objective of the present invention is to provide a hub apparatus, and in particular, a hub apparatus that can automatically load corresponding power to a connection portion of the hub apparatus.

In a preferable embodiment, the present invention provides a hub apparatus, including:

a connection portion, configured to connect to an electronic apparatus;

an interface detection portion, electrically coupled to the connection portion;

a power control portion, electrically coupled to the connection portion;

a hub control portion, electrically coupled to the power control portion; and

a microcontroller, electrically coupled to the interface detection portion, the power control portion, and the hub control portion, and after obtaining an interface type of the electronic apparatus by using the interface detection portion, controlling the hub control portion according to the interface type to supply corresponding power to the connection portion by using the power control portion.

### BRIEF DESCRIPTION OF THE DRAWINGS

FIG. 1 is a schematic conceptual operational diagram of a conventional hub apparatus and an electronic computer apparatus.

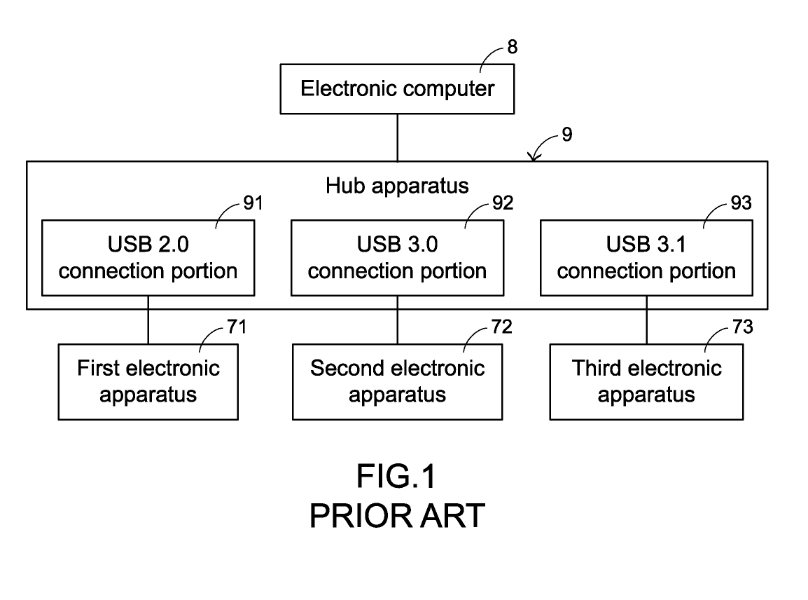

FIG. 2 is a schematic conceptual block diagram of a first preferable embodiment of a hub apparatus according to the present invention.

FIG. 3 is a schematic conceptual block diagram of a second preferable embodiment of a hub apparatus according to the present invention.

### DETAILED DESCRIPTION OF THE PREFERRED EMBODIMENT

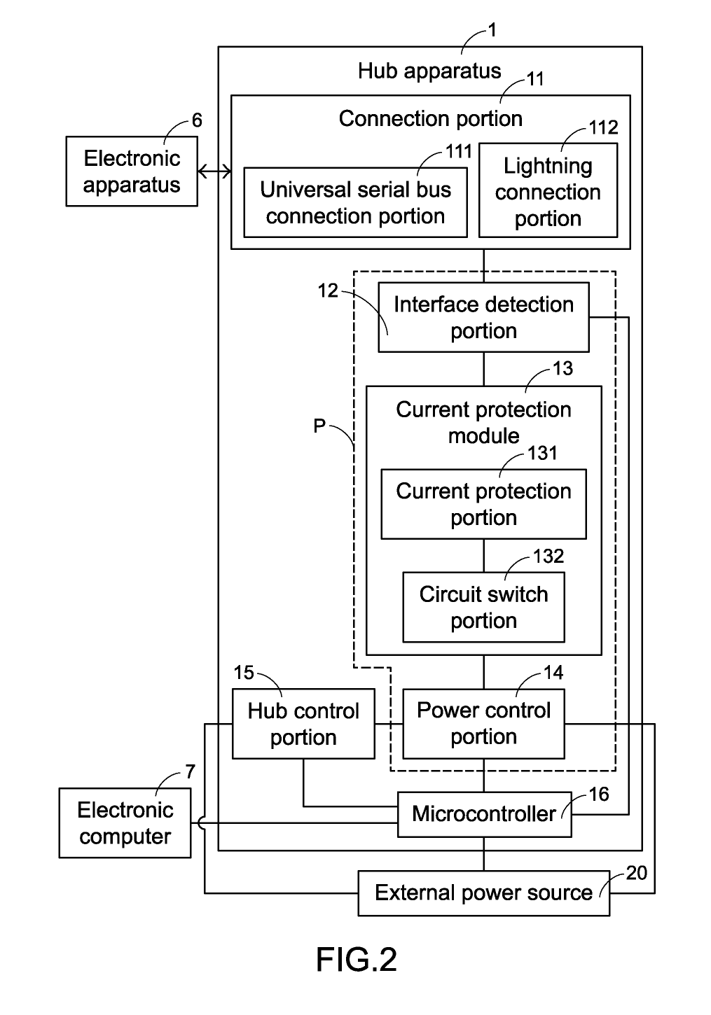

Referring to FIG. 2, FIG. 2 is a schematic block conceptual diagram of a first preferable embodiment of a hub apparatus according to the present invention. The hub apparatus 1 includes a connection portion 11, an interface detection portion 12, a current protection module 13, a power control portion 14, a hub control portion 15, and a microcontroller 16. An electronic apparatus 6 is connected to the connection portion 11, and the microcontroller 16 is electrically coupled to the interface detection portion 12, the power control portion 14, and the hub control portion 15. The interface detection portion 12 is electrically coupled to the connection portion 11 and the current protection module 13. Preferably, but not limiting to the present invention, the interface detection portion 12, the power control portion 14, and the hub control portion 15 may be respectively formed by one or more chips.

In addition, the hub apparatus 1 may be connected to an electronic computer 7 by using a connection line, and after the hub apparatus 1 is connected to the electronic computer 7, the microcontroller 16 is electrically coupled to the electronic computer 7, so that the electronic apparatus 6 connected to the connection portion 11 may perform data file or power transmission with the electronic computer 7. Therefore, the electronic computer 7 may be used as a power source of the hub apparatus 1.

In this preferable embodiment, the power control portion 14, the hub control portion 15, and the microcontroller 16 are all electrically coupled to an external power source 20. Therefore, the external power source 20 may supply power to the hub apparatus 1 and becomes another power source of the hub apparatus 1. The connection portion 11 includes a universal serial bus (USB) connection portion 111 and a lightning connection portion 112, and the USB connection portion 111 includes a USB 2.0 connection portion, a USB 3.0 connection portion, a USB 3.1 connection portion, and a USB Type-C connection portion. A lightning interface controller (not shown in the figure) is disposed in the lightning connection portion 112, but the present invention is not limited thereto.

Further, the electronic apparatus 6 may be connected to the USB connection portion 111 or the lightning connection portion 112 according to an interface type of the electronic apparatus 6, and after the electronic apparatus 6 is connected to the connection portion 111, the microcontroller 16 may detect the interface type of the electronic apparatus 6 by using the interface detection portion 12. For example, if a transmission interface of the electronic apparatus 6 is USB 2.0, the electronic apparatus 6 may be connected to the USB 2.0 connection portion of the USB connection portion 111, and the microcontroller 16 may detect the interface type of the electronic apparatus 6 as USB 2.0 by using the interface detection portion 12. The manner of detecting the interface type of the electronic apparatus 6 by using the interface detection portion 12 is known by a person skilled in the art; and therefore, details are not described herein.

In addition, in this preferable embodiment, the current protection module 13 is electrically coupled between the interface detection portion 12 and the power control portion 14, and the power control portion 14, the current protection module 13, and the interface detection portion 12 form a power supply circuit P for supplying power to the connection portion 11. When the electronic apparatus 6 is connected to the connection portion 11, the current protection module 13 may be configured to determine whether the connection portion 11 is electrically overloaded due to the connection to the electronic apparatus 6.

Further, in this preferable embodiment, the current protection module 13 includes a current protection portion 131 and a circuit switch portion 132. The current protection portion 131 is configured to detect whether the connection portion 11 is electrically overloaded, and when the current protection portion 131 detects that the connection portion 11 is electrically overloaded, the current protection portion 131 drives the circuit switch portion 132 to be switched off, and cuts off the power supply circuit P by switching off the circuit switch portion 132, so as to protect the hub apparatus 1 and the electronic apparatus 6. Preferably, but not limiting to the present invention, the current protection portion 131 and the circuit switch portion 132 are respectively formed by one or more chips.

In addition, although the current protection module 13 shown in FIG. 2 only includes one group of the current protection portion 131 and the circuit switch portion 132, this is not limited in actual application, and a person skilled in the art may adjust the current protection module 13 according to a set quantity of the USB connection portions 111 and the lightning connection portions 112 in the connection portion 11. For example, one or more groups of the current protection portions 131 and the circuit switch portions 132 are disposed.

It should be specifically noted that, in the present invention, after the microcontroller 16 obtains the interface type of the electronic apparatus 6 by means of detection of the interface detection portion 12, the microcontroller further controls the hub control portion 15 according to the obtained interface type to supply corresponding power to the connection portion 11 by using the power control portion 14. Preferably, but not limiting to the present invention, the power control portion 14 is further configured to detect whether the power supplied to the connection portion 11 reaches required power, and if the power control portion 14 detects that the power supplied to the connection portion 11 does not reach the required power, the power control portion 14 outputs an abnormal signal to the hub control portion 15, and the hub control portion 15 performs modulation after receiving the abnormal signal, to supply the required power to the connection portion 11 by using the power control portion 15.

For example, when the interface type of the electronic apparatus 6 that is obtained by the microcontroller 16 by using the interface detection portion 12 is USB 3.0, the microcontroller 16 controls the hub control portion 15 to supply power of 900 mA to the USB 3.0 connection portion by using the power control portion 14. In addition, the power control portion 14 also detects whether the power supplied to the USB 3.0 connection portion actually reaches 900 mA. If the power control portion 14 detects that the power supplied to the USB 3.0 connection portion does not reach 900 mA, the power control portion 14 outputs an abnormal signal to the hub control portion 15, and the hub control portion 15 performs modulation after receiving the abnormal signal, to supply power that actually reaches 900 mA to the USB 3.0 connection portion by using the power control portion 15.

According to the foregoing descriptions, the hub apparatus 1 of this solution has a function of automatically loading required power to the connection portion 11. When multiple electronic apparatuses 6 are connected to the connection portion 11 at the same time, for example, when an electronic apparatus 6 whose transmission interface is USB 2.0, an electronic apparatus 6 whose transmission interface is USB 3.0, and an electronic apparatus 6 whose transmission interface is USB 3.1 are respectively connected to the USB 2.0 connection portion, the USB 3.0 connection portion, and the USB 3.1 connection portion, the hub apparatus 1 may load different power according to different interface types, to overcome the disadvantage that conventional electronic apparatuses with different transmission interfaces can obtain only same power. In addition, because in this solution, an external power source is used as a power source of the hub apparatus 1, the connection portions may all be in the maximum power load.

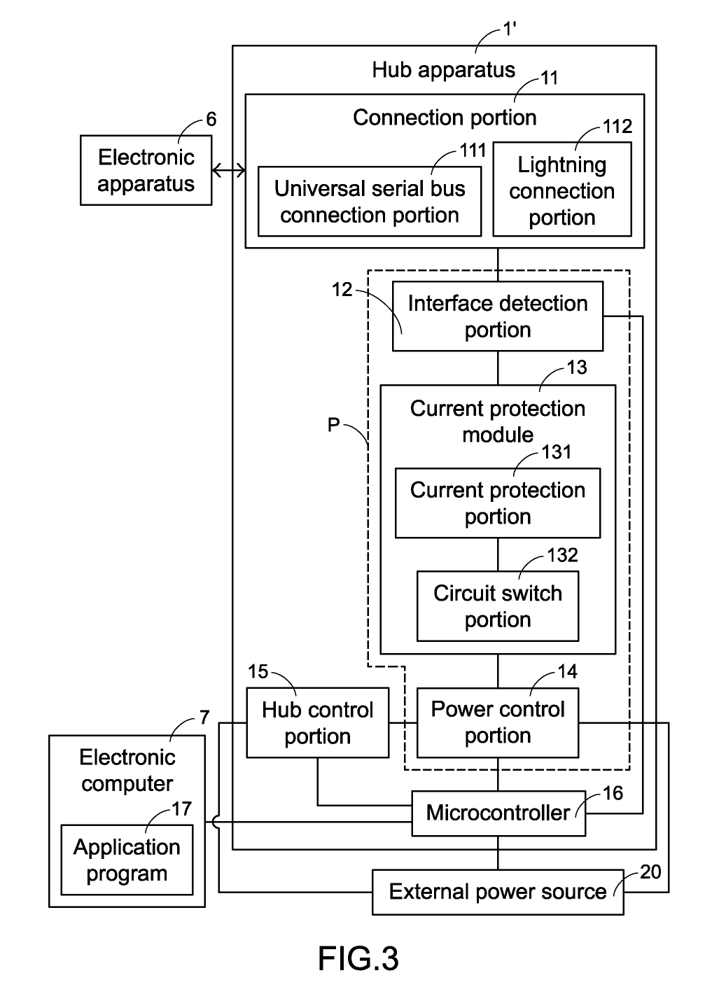

Referring to FIG. 3, FIG. 3 is a schematic block conceptual diagram of a second preferable embodiment of a hub apparatus according to the present invention. A hub apparatus 1′ in this preferable embodiment is roughly similar to the hub apparatus 1 in the first preferable embodiment of this solution, and details are not described herein again. A difference between this preferable embodiment and the first preferable embodiment is: the hub apparatus 1′ is applied to a production line, and the hub apparatus 1′ further includes an application program 17 installed on an electronic computer 7, so that the electronic computer 7 may display status information of the hub apparatus 1′, for operators on the production line to perform various tests and operations on one or more electronic apparatuses 6 connected to the hub apparatus F. The status information may include the interface type of the electronic apparatus 6 that is detected by the interface detection portion 12, an operating status of the current protection module 13 (for example, whether a power supply circuit P is cut off because the circuit switch portion 132 is switched off), whether a power value detected by the power control portion 14 reaches required power, and the like. The application field of the hub apparatus 1′ is not limited to the production line, and a person skilled in the art may apply the hub apparatus to various fields according to actual application requirements.

The foregoing descriptions are merely preferable embodiments of the present invention, and are not used to limit the application scope of the present invention. Therefore, other equivalent variations or modifications made without departing from the spirit of the present invention shall fall within the application scope of the present invention.

What is claimed is:

1. A hub apparatus, comprising:
a connection portion, configured to connect to an electronic apparatus;
an interface detection portion, electrically coupled to the connection portion;
a power control portion, electrically coupled to the connection portion;
a hub control portion, electrically coupled to the power control portion; and
a microcontroller, electrically coupled to the interface detection portion, the power control portion, and the hub control portion, and after obtaining an interface type of the electronic apparatus by using the interface detection portion, controlling the hub control portion according to the interface type to supply corresponding power to the connection portion by using the power control portion.

2. The hub apparatus according to claim 1, further comprising a current protection module, wherein the current protection module is electrically coupled to the connection portion, and is configured to determine whether the connection portion is electrically overloaded.

3. The hub apparatus according to claim 2, wherein the interface detection portion is connected between the connection portion and the current protection module.

4. The hub apparatus according to claim 2, wherein the current protection module comprises a current protection portion and a circuit switch portion, and the current protection portion is configured to detect whether the connection portion is electrically overloaded; and when the current protection portion detects that the connection portion is electrically overloaded, the circuit switch portion cuts off power from passing through the circuit switch portion.

5. The hub apparatus according to claim 1, wherein at least one of the power control portion, the hub control portion, and the microcontroller is electrically coupled to an external power source.

6. The hub apparatus according to claim 1, wherein the connection portion comprises at least one of a universal serial bus (USB) connection portion and a lightning connection portion.

7. The hub apparatus according to claim 1, wherein the USB connection portion comprises at least one of a USB 2.0 connection portion, a USB 3.0 connection portion, a USB 3.1 connection portion, and a USB Type-C connection portion.

8. The hub apparatus according to claim 1, wherein the power control portion is further configured to detect whether power supplied to the connection portion reaches the corresponding power.

9. The hub apparatus according to claim 8, wherein the power control portion outputs an abnormal signal to the hub control portion when detecting that the power supplied to the connection portion does not reach the corresponding power, and the hub control portion performs modulation after receiving the abnormal signal, to supply the corresponding power to the connection portion by using the power control portion.

10. The hub apparatus according to claim 1, further comprising an application program, wherein the application program is installed on an electronic computer electrically coupled to the microcontroller, to make the electronic computer display status information of the hub apparatus.
